(19) United States
(12) Patent Application Publication
(10) Pub. No.: US 2018/0096243 A1
(43) Pub. Date: Apr. 5, 2018

(54) DEEP LEARNING FOR DATA DRIVEN FEATURE REPRESENTATION AND ANOMALY DETECTION

(71) Applicant: General Electric Company, Schenectady, NY (US)

(72) Inventors: Sundeep R PATIL, Garching b. Munchen (DE); Ansh KAPIL, Munich (DE); Oliver BAPTISTA, Garching (DE)

(21) Appl. No.: 15/282,058

(22) Filed: Sep. 30, 2016

(51) Int. Cl. G06N 3/08; G06N 3/04

(52) U.S. Cl. CPC G06N 3/08; G06N 3/0472

(57) ABSTRACT

The present embodiments relate to a system and method associated with anomaly classification. The method comprises receiving a plurality of time-series data from one or more sensors associated with a machine. The time-series data may be automatically passed through a convolutional neural network to determine reduced dimension data. An anomaly based on classifying the reduced dimension data may be automatically determined. In a case that the anomaly is an unknown anomaly, the determined anomaly may be labeled and the determined anomaly and its associated label may be stored in an anomaly training database.

### BACKGROUND

Maintenance of various machines such as, but not limited to, engines, turbines, rail vehicles and aircraft, is essential for the longevity of the machines. Early detection and diagnosis of faults or anomalies associated with the machines may help avoid loss of use of the machines as well as prevent secondary damage. For example, various components associated with a machine may breakdown over time and failure to diagnose and repair these breakdowns may lead to loss of use of the machine or, in some cases, the breakdowns may cause damage to other components of the machine thus causing secondary damage.

It would therefore be desirable to provide a system to quickly and accurately determine faults or anomalies associated with a machine as early as possible to provide time for a repair crew to address the determined or anomalies associated with the machine.

### SUMMARY

According to some embodiments, the present embodiments relate to a method and system for determining an anomaly associated with a machine. The method comprises receiving a plurality of time-series data from the machine. The time-series data may be automatically passed through a convolutional neural network to determine reduced dimension data. An anomaly based on classifying the reduced dimension data may be automatically determined via a processor. In a case that the anomaly is an unknown anomaly, the determined anomaly may be labeled and stored in an anomaly training database.

A technical advantage of some embodiments disclosed herein are improved systems and methods for early detection and diagnosis of anomalies associated with machines through the use of convolutional neural networks which are easier to train and have many fewer parameters than fully connected networks.

### BRIEF DESCRIPTION OF THE DRAWINGS

FIG. 1 is a high-level architecture of an anomaly classification system in accordance with some embodiments.

FIG. 2 illustrates a process according to some embodiments.

FIG. 2A illustrates a process according to some embodiments.

FIG. 3 illustrates a process flow through a convolutional neural network in accordance with some embodiments.

FIG. 4 illustrates a convolutional neural network in accordance with some embodiments.

FIG. 5 illustrates convolutional neural network testing according to some embodiments.

FIG. 6 illustrates convolutional neural network training in accordance with some embodiments.

FIG. 7 illustrates a system according to some embodiments.

FIG. 8 illustrates a portion of a database table according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present embodiments described herein relate to the use of a convolutional neural network (“CNN”) to classify and/or detect anomalies/faults in time-series data transmitted from sensors that are coupled to a machine (e.g., an engine, a turbine, an aircraft, a rail vehicle, etc.). Conventional system architectures associated with CNNs are typically designed to take advantage of a structure associated within an input (e.g., a graphic image). For example, a conventional CNN system may comprise a plurality of convolutional layers that relate to a derived function which may be used to express how a shape, within an image, and associated with a first function is modified by a second function. However, the architectures described herein relate to a method and system of using a CNN to determine anomalies associated with time-series data, instead of images.

A CNN to determine anomalies associated with time-series data may comprise a plurality of layers, such as, but not limited to, convolutional layers, subsampling layers and fully connected layers. In some embodiments, the convolutional layers may be followed by activation layers (ReLu), and/or pooling layers and fully connected layer. The order and the number of these layers may vary with different architectures. Anomalies that are detected by a CNN may then be classified and labeled.

Each convolutional layer of the CNN may receive a fixed width data input window (e.g., m×n data window). Each convolutional layer may be comprised of kernels (i.e., filters) that are smaller than the dimensions of the input data window. Kernel upon convolution may give rise to a locally connected receptive field. K filters may be convolved with the input data to produce k feature maps, and further each feature map may be subsampled typically with mean or max pooling over p×p contiguous regions of the input data where p may range between 2 and 5 regions based on a size of the input data. The subsampled feature maps may serve as an input to a next convolutional layer/activation layer. A benefit of using a CNN is that it learns the patterns in data rather than the location of the data as opposed to the fully connected neural networks.

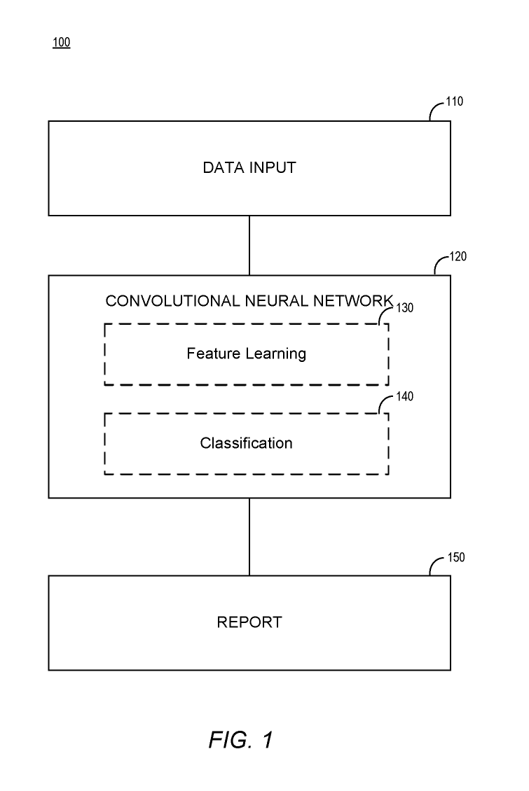

Now referring to FIG. 1, an embodiment of a high-level architecture of an anomaly classification system 100 is illustrated. The anomaly classification system 100 may comprise a data input device 110, a convolutional neural network system 120 and a reporting device 150. The data input device 110 may comprise one or more sensors that collect data associated with a particular machine. For example, sensors may be associated with temperature, voltage, vibration, etc. In some embodiments, a machine may comprise, but is not limited to, an engine, an airplane, a turbine or a rail vehicle such as a train or locomotive.

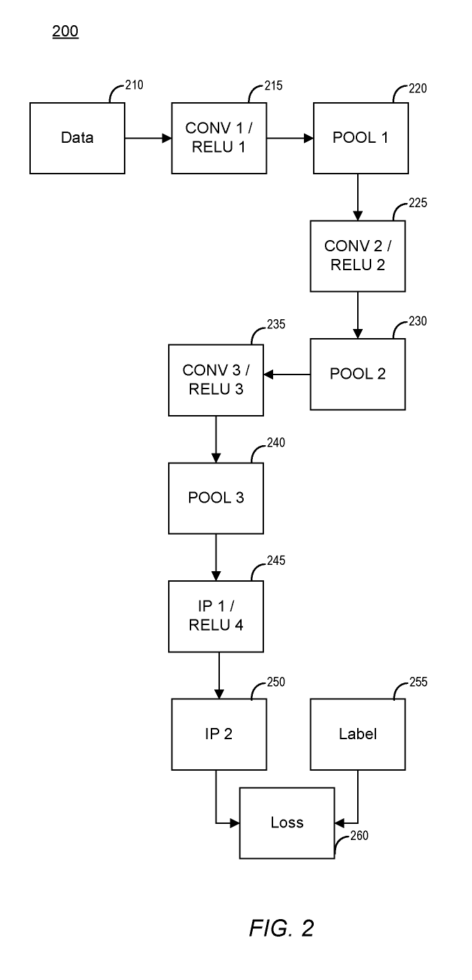

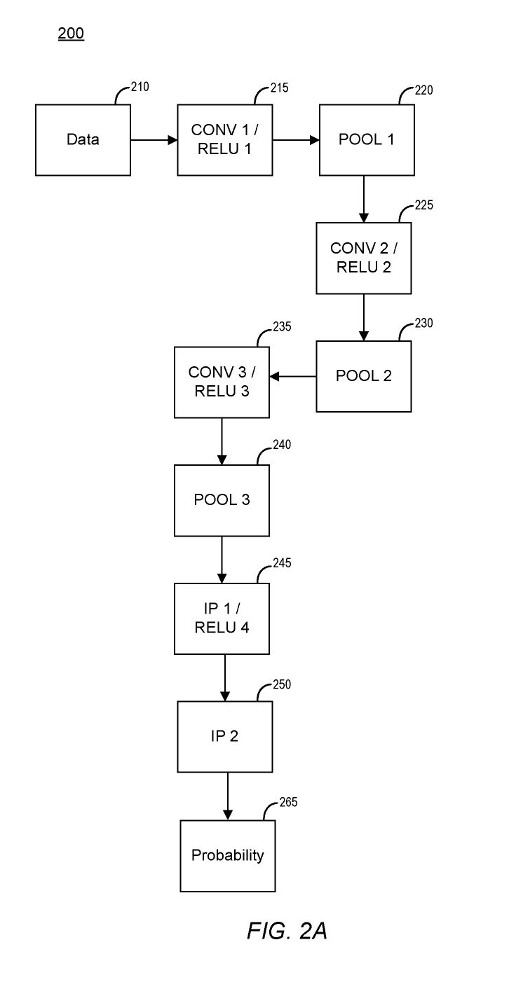

Data from the data input device 110 may be fed into a convolutional neural network system 120. The convolutional neural network system 120 may comprise a feature learning function 130 and a classification function 140. For example, and now referring to FIG. 2, an embodiment of a process flow 200 through a convolutional neural network is illustrated. In some embodiments, FIG. 2 may represent a runtime configuration of a convolutional neural network. In other embodiments, FIG. 2 may represent a runtime configuration of a convolutional neural network as will be explained in more detail with respect to FIG. 2A.

As illustrated in the process flow 200, data 210 from a data input device may be processed by a feature learning function by passing the data 210 through a plurality of convolutional neural network layers. In some embodiments, each of the plurality of convolutional neural network layers may utilize rectified linear units.

Passing the data 210 through the layers of the convolutional neural network may facilitate the determination of features associated with the data 210 by reducing a number of dimensions associated with the data 210. For example, the data 210 may originally comprise 12,000 dimensions and after being passed through the plurality of layers associated with the convolutional neural network, the number of dimensions associated with the third pool data may comprise only 64 dimensions. The convolutions and the subsampling of the data may reduce the dimensions of the data. For example, m×m data convolved with f×f filter with stride s and padding p will lead to an output of (m−f+2p)*s+1. A standard activation function such as sigmoid, hyperbolic tangent and rectified linear units may be used. In the illustrated embodiment, rectifier linear units or rectifier neural units may be used.

The data 210 may comprise a large number of dimensions (e.g., 12,000 dimensions) and may be passed through a first layer of the convolutional neural network at 215. An outcome of passing the data 210 through the first layer 215 of the convolutional neural network may be followed by first pooling 220 and represented as first pool data. The first pool data may comprise fewer dimensions than the data 210. The first pool data may be passed through a second layer of the convolutional neural network at 225. An outcome of passing the first pool data through the second layer 225 of the convolutional neural network may be followed by a second pooling 230 and represented as second pool data. The second pool data may comprise fewer dimensions than the first pool data. The second pool data may be passed through a third layer of the convolutional neural network at 235. An outcome of passing the second pool data through the third layer 235 of the convolutional neural network may be followed by a third pool 240 and represented as third pool data. The third pool data may comprise fewer dimensions than the second pool data. For example, the data 210 may comprise 12,000 dimensions before being passed through the three layers of the convolutional neural network and the data 210 may be output as reduced dimension data comprising 64 dimensions. After reducing the number of dimensions, the reduced dimension data may be fed into a classifier.

At 245, a first inner product may be performed on the third pool data. The first inner product may relate to a dot product and, for example, the inner product may multiply vectors together, where the result of this multiplication is a scalar value. An output of the first inner product may be used as input of a second inner product 250 calculation.

An output of the second inner product 250 may be passed to a loss layer to compare with one or more labels 255. The labels 255 may be stored in an anomaly training database. Each comparison with the one or more labels 255 may add to the loss 260. The loss may be defined as a training error i.e. a measure of mapping between an output of the second inner product 250. A zero loss indicates a 100% correct classification. As the loss increases, a likelihood of a classification being correct is reduced.

Determining the loss (e.g., based on a cost/error function) may comprise mapping a set of values (e.g., the feature associated with the feature learning function 130) to class labels. Intuitively, the loss may be high if classifying the training data is not accurate and the loss may be low if the classifying the training data is accurate. The loss function may be parameterized by weights and bias (W,b). The loss associated with the convolutional neural network may be optimized so that the loss may be as low as possible which indicates that a classifier is mapping inputs correctly to the anomaly classes. Hence, the loss function is optimized, which is parameterized in W,b (W=weight matrices in different layers, b=bias) until the loss is low enough.

In some embodiments, a verification step may be used to ensure that the training is giving accurate results to ensure that the classification is accurate. The verification step may consist of testing the trained network on a small subset of labelled data which is not used for training. A forward pass may be performed with the trained network and the results may be verified with ground truth labels of the labelled dataset which may give an estimate of the performance of the network.

In some embodiments, the data 210 may be initially compared to known time-series data associated with a machine to determine the presence of an anomaly. However, in some embodiments, for each computed low dimensional feature space, two different probabilities may be provided: the first being a probability of the output of the second inner product 250 comprises an anomaly and the second being a probability that the output of the second inner product 250 does not comprise an anomaly. The first inner product and the second inner product may be associated with a classifier.

Referring back to FIG. 1, once the convolutional neural network device 120 processes the received data from the data input device 110 through the feature learning function 130 and the classification function 140, a report may be generated via the report device 150.

Now referring to FIG. 2A, an embodiment of a runtime configuration of a convolutional neural network 200 is illustrated. Unlike the runtime configuration of FIG. 2, in the runtime configuration of FIG. 2A, labels are not provided. Instead the labels are predicted at a probability layer 265 which, in some embodiments, is a last step in the runtime configuration. During the deployment time, a convolutional neural network may only predict probabilities of the input time-series data as comprising an anomaly or not comprising an anomaly. In the runtime configuration of FIG. 2A, loss estimation may not be calculated and loss estimation may only be used for a training phase such as the runtime configuration of FIG. 2.

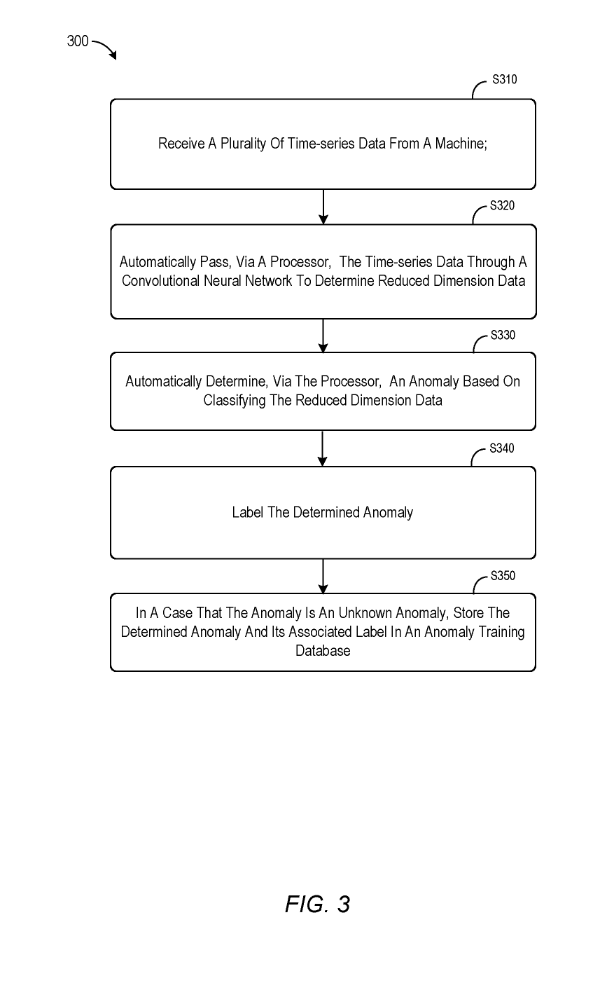

FIG. 3 illustrates a method 300 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

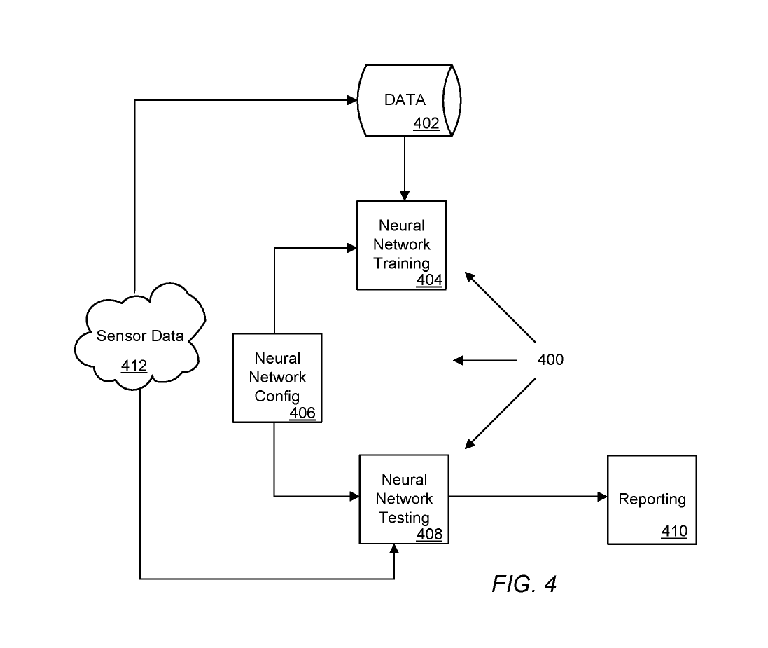

At S310, a plurality of time-series data from one or more sensors associated with a machine is received. The time-series data may be received at a convolutional neural network and the time-series data may be used for the detection and classification of anomalies in the time-series data. The time-series data may be received from one or more sensors that are associated with a machine (e.g., an engine, an airplane, a rail vehicle, etc.). The convolutional neural network may be described in more detail with respect to FIG. 4 which illustrates a convolutional neural network 400 in accordance with some embodiments. As illustrated in FIG. 4, sensor data 412 may be streamed to the convolutional neural network 400. The sensor data 412 may be stored in a data repository 402 and fed into a neural network training unit 408.

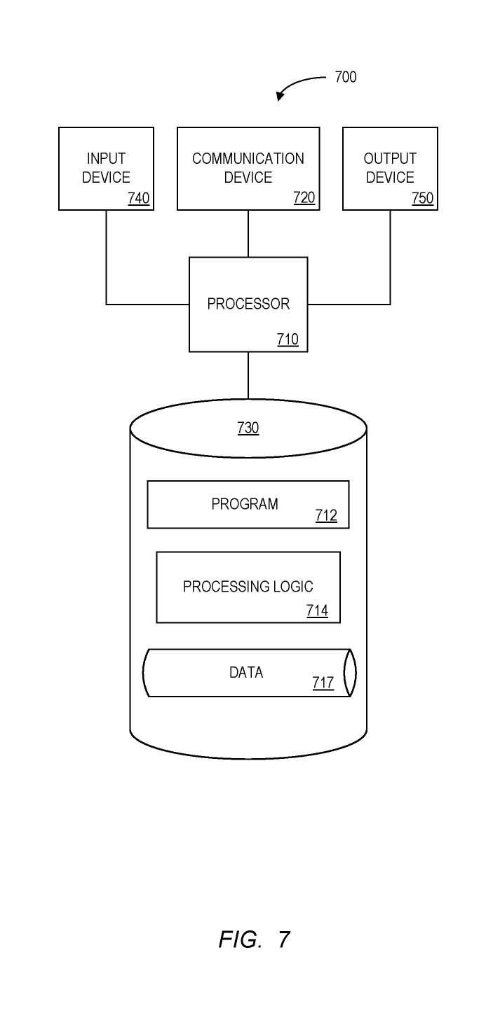

Referring back to FIG. 3, at S320, the time-series data may automatically be passed through the convolutional neural network to determine reduced dimension data. The passing through the convolutional neural network may be performed by a processor such as the processor described with respect to FIG. 7. The received data may be fed into a neural network testing unit such as neural testing unit 408 of FIG. 4. For a convolutional neural network to learn about specific features of a signal, as well as potential anomalies, the convolutional neural network must first be trained (e.g., taught which features are normal and which are anomalies).

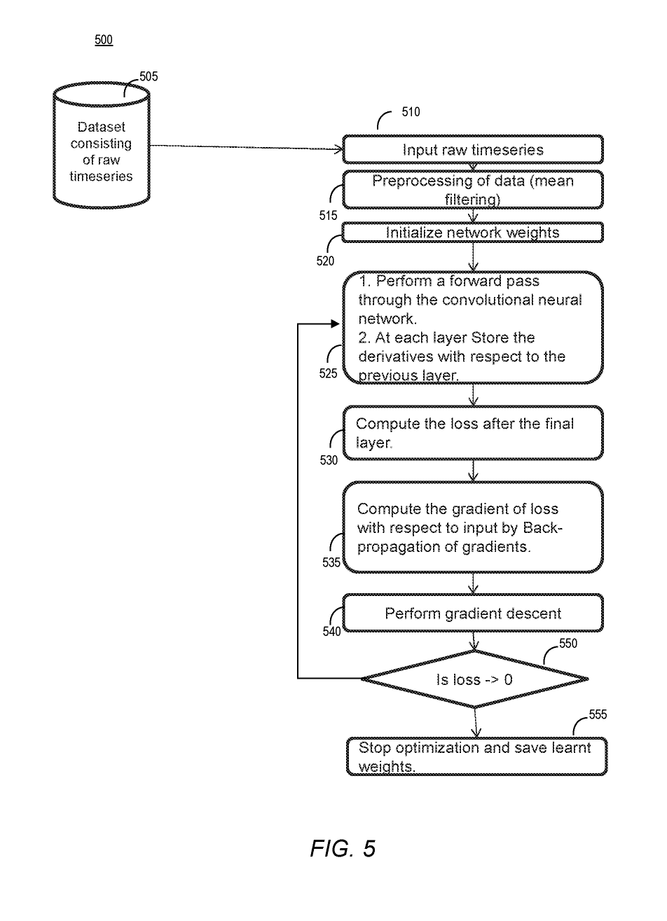

Now referring to FIG. 5, an embodiment of a convolutional neural network training process 500 is illustrated. At 510, a data set comprising raw time-series data 505 is received (e.g., input). The raw time-series data 505 may be preprocessed at 515. For example, the raw time-series data 505 may be subjected to mean filtering which may comprise a sliding-window spatial filter that replaces a center value in a window with a mean value of all the values in the window.

Next, at 520, weights for the convolutional neural network may be initialized. The initialization process may be performed by a convolutional neural network configuration function such as neural network configuration unit 406. Final values of every weight used in the convolutional neural network may not be known and are randomly assigned and, in some embodiments, approximately half of the weights will be positive and half of them will be negative. In some embodiments, the initial weights may not be zero but instead; the initial weights may be very close to zero. For example, the initial weights may comprise very small numbers.

Next, at 525, a forward pass through the convolutional neural network may be performed for each layer of the convolutional neural network. At each layer, gradients associated with a previous layer may be stored. After the forward pass through each layer is performed, at 530 a final loss may be calculated.

At 535, a gradient of loss with respect to the input may be computed by backpropagation of gradients. Backpropagation may comprise a method of providing detailed insights into how changing the weights and biases may change an overall behavior of a convolutional neural network.

At 540 a gradient descent is performed. In some embodiments, a gradient descent may comprise an iterative optimization algorithm. For example, in some embodiments a gradient descent may be used to determine a smallest value of a function.

At 550 a determination is made if a loss equals zero or is within a margin of error of zero. If the loss equals zero, or is within a margin of error of zero, at 555, optimization may be halted and weights that are determined may be saved for use in a convolutional neural network testing process.

Referring back to FIG. 3, at S330 an anomaly may automatically be determined, via a processor, based on classifying the reduced dimension data. Classifying the reduced dimension data may be based on optimization of the loss function in the training process by mapping the determined low dimensional feature space with one label stored in an anomaly training database. Classification of a determined feature space may be based on a convolutional neural network testing process.

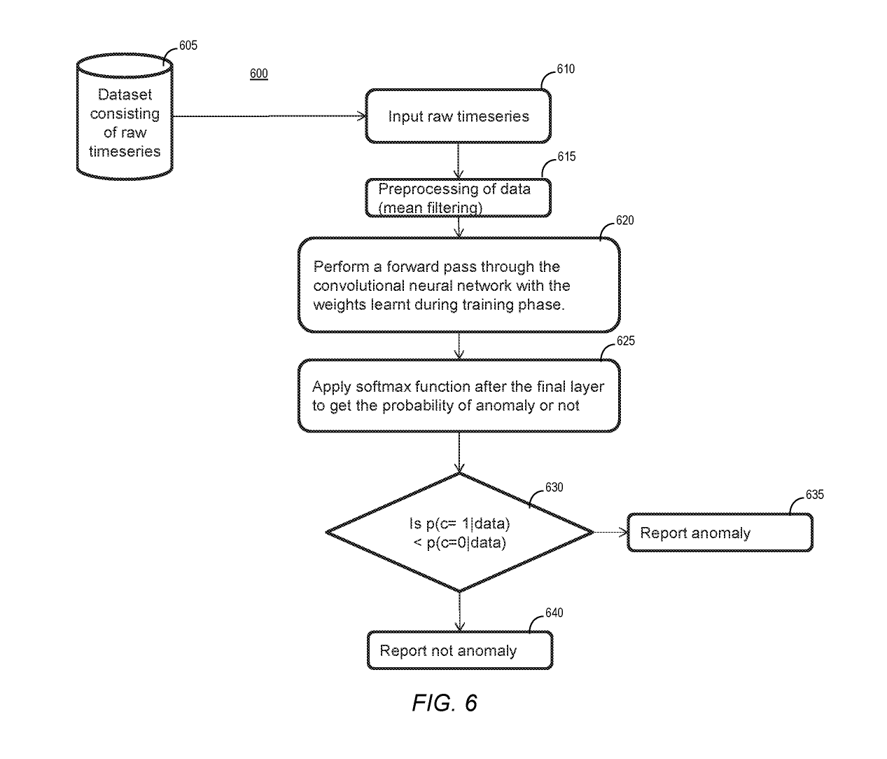

Now referring to FIG. 6, an embodiment of a convolutional neural network testing process 600 is illustrated. At 610, a data set comprising raw time-series data 605 is received (e.g., input). The raw time-series data 605 may be preprocessed at 615. For example, the raw time-series data 605 may be subjected to mean filtering which may comprise a sliding-window spatial filter that replaces a center value in a window with a mean value of all the values in the window.

Next, at 620, a forward pass through the convolutional neural network may be performed using weights that are learned during a training phase as described with respect to FIG. 5. At 625, a softmax function may be applied to determine a probability of a presence of an anomaly. In a case of convolutional neural networks, the softmax function may typically be used for classification after passing data through the final layer of the convolutional neural network.

At 630, a probability that the output of the softmax function is closer to a known anomaly that is stored in the data repository 402 may be determined. For example, a determination may be made if a probability that an output of the softmax function is closer to a known label (e.g., anomaly) than not. If it is determined that there is a likelihood that a one or more feature associated with the input data is an anomaly, the anomaly is reported at 635. If it is determined that there is no likelihood of an anomaly (percentage is less than 50 percent), then either no report is made or a report indicating a lack of an anomaly is made at 640. For example, a reporting unit 410 may provide reports to end users.

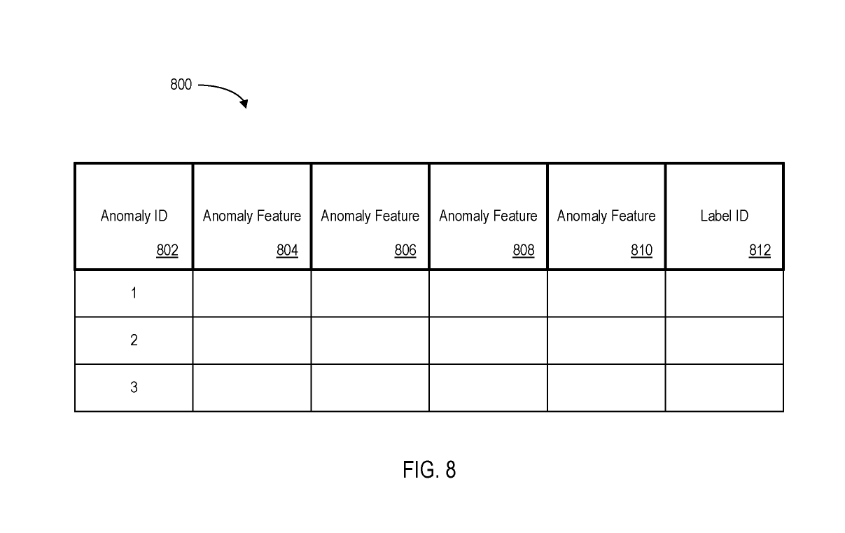

Referring back to FIG. 3, in a case that there is a likelihood of an anomaly, at 340, the determined anomaly is labeled. Labeling may comprise assigning the anomaly a unique identifier that is associated with a plurality of anomaly features. At 350, the determined anomaly and its associated label are stored in an anomaly training database. The unique identifier as well as the anomaly features may be stored in a database such as the database described with respect to FIG. 8.

Note the embodiments described herein may be implemented using any number of different hardware configurations. For example, FIG. 7 illustrates a convolutional neural network system 700 that may be, for example, associated with the anomaly classification system 100 of FIG. 1. The convolutional neural network system 700 may comprise a processor 710 (“processor”), such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more users. The convolutional neural network system 700 further includes an input device 740 (e.g., a mouse and/or keyboard to enter information about the measurements and/or assets) and an output device 750 (e.g., to output and display the data and/or recommendations).

The processor 710 also communicates with a memory/storage device 730. The storage device 730 may comprise any appropriate information storage device, including combinations of magnetic storage devices (e.g., a hard disk drive), optical storage devices, mobile telephones, and/or semiconductor memory devices. The storage device 730 may store a program 712 and/or geometrical compensation processing logic 714 for controlling the processor 710. The processor 710 performs instructions of the programs 712, 714, and thereby operates in accordance with any of the embodiments described herein. For example, the processor 710 may receive data from a machine and may create a model based on the data and/or may also detect and/or classify anomalies via the instructions of the programs 712, 714.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the platform 700 from another device; or (ii) a software application or module within the platform 700 from another software application, module, or any other source.

FIG. 8 is a tabular view of a portion of a database 800 in accordance with some embodiments of the present invention. The table includes entries associated with anomaly data and labels. The table also defines fields 802, 804, 806, 808, 810, and 812 for each of the entries. The fields specify: a anomaly ID 802, a first anomaly feature ID 804, a second anomaly feature 806, a third anomaly feature 808, a Nth anomaly feature 810 and a label ID 812. The information in the database 800 may be periodically created and updated based on information collection during operation of machines as they are received from one or more sensors.

The anomaly ID 802 might be a unique alphanumeric code identifying a specific type of anomaly and the anomaly features 804/806/808/810 might identify a specific features associated with a specific anomaly such as frequencies, patterns of a signal, etc. The label ID 812 might be a unique alphanumeric code identifying a specific label of a known anomaly.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a convolutional neural network system. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A method of determining an anomaly associated with a machine, the method comprising:
receiving a plurality of time-series data from one or more sensors associated with a machine;
automatically passing, via a processor, the time-series data through a convolutional neural network to determine reduced dimension data;
automatically determining, via the processor, an anomaly based on classifying the reduced dimension data; and
in a case that the anomaly is an unknown anomaly, labeling the determined anomaly and storing the determined anomaly and its associated label in an anomaly training database.

2. The method of claim 1, wherein passing the time-series data through a convolutional neural network to determine reduced dimension data; comprises:
performing a first pass through the a first layer of the convolutional neural network to reduce a number of dimensions of the plurality of time-series data;
pooling the outcome of performing the first pass as first pool data;
performing a second pass through the a second layer of the convolutional neural network to reduce a number of dimensions of the first pool data;
pooling the outcome of performing the second pass as second pool data;
performing a third pass through the a third layer of the convolutional neural network to reduce a number of dimensions of the second pool data;
pooling the outcome of performing the third pass as third pool data; and
performing one or more inner products on the third pool data to create the reduced dimension data.

3. The method of claim 2, wherein automatically determining anomalies based on classifying the reduced dimension data comprises:
receiving the reduced dimension data at a classifier; and
determining (i) a probability that the reduced dimension data comprises an anomaly and (ii) a probability that the reduced dimension data does not comprise an anomaly.

4. The method of claim 3, wherein determining (i) the probability that the reduced dimension data comprises an anomaly and (ii) the probability that the reduced dimension data does not comprise an anomaly comprises:
training a system to map the reduced dimension data to a plurality of labels by computation and optimization associated with a loss function.

5. The method of claim 4, wherein the one or more inner products comprise a first inner product performed on the third pool data and a second inner product performed on an output of the first inner product; and
passing the reduced dimension data to the classifier to determine (i) the probability that the reduced dimension data comprises an anomaly and (ii) the probability that the reduced dimension data does not comprise an anomaly.

6. The method of claim 3, wherein the reduced dimension data comprises 64 dimensions.

7. A system comprising:
a database server comprising an anomaly training database; and
a processor in communication with a machine to:
receive a plurality of time-series data from one or more sensors associated with the machine;
automatically pass the time-series data through a plurality of layers of a convolutional neural network to determine reduced dimension data;
automatically determine an anomaly based on classifying the reduced dimension data;
label the determined anomaly; and
store the determined anomaly and its associated label in the anomaly training database.

8. The system of claim 7, wherein passing the time-series data through a convolutional neural network to determine reduced dimension data; comprises:
performing a first pass through the a first layer of the convolutional neural network to reduce a number of dimensions of the plurality of time-series data;
pooling the outcome of performing the first pass as first pool data;
performing a second pass through the a second layer of the convolutional neural network to reduce a number of dimensions of the first pool data;
pooling the outcome of performing the second pass as second pool data;
performing a third pass through the a third layer of the convolutional neural network to reduce a number of dimensions of the second pool data;
pooling the outcome of performing the third pass as third pool data; and
performing one or more inner products on the third pool data to create the reduced dimension data.

9. The system of claim 8, wherein automatically determining anomalies based on classifying the reduced dimension data comprises:
receiving the reduced dimension data at a classifier; and
determining (i) a probability that the reduced dimension data comprises an anomaly and (ii) a probability that the reduced dimension data does not comprise an anomaly.

10. The system of claim 9, wherein determining (i) the probability that the reduced dimension data comprises an anomaly and (ii) the probability that the reduced dimension data does not comprise an anomaly comprises:
training a system to map the reduced dimension data to a plurality of labels by computation and optimization associated with a loss function.

11. The system of claim 10, wherein the one or more inner products comprise a first inner product performed on the third pool data and a second inner product performed on an output of the first inner product; and
passing the reduced dimension data to the classifier to determine (i) the probability that the reduced dimension data comprises an anomaly and (ii) the probability that the reduced dimension data does not comprise an anomaly.

12. The system of claim 9, wherein the reduced dimension data comprises 64 dimensions.

13. A non-transitory computer-readable medium comprising instructions that when executed by a processor perform a method of anomaly detection, the method comprising:
receiving a plurality of time-series data from one or more sensors associated with a machine;
automatically passing, via a processor, the time-series data through a convolutional neural network to determine reduced dimension data;
automatically determining, via the processor, an anomaly based on classifying the reduced dimension data based on a determined loss;
labeling the determined anomaly; and
storing the determined anomaly and its associated label in an anomaly training database.

14. The medium of claim 13, wherein passing the time-series data through a convolutional neural network to determine reduced dimension data; comprises:
performing a first pass through the a first layer of the convolutional neural network to reduce a number of dimensions of the plurality of time-series data;
pooling the outcome of performing the first pass as first pool data;
performing a second pass through the a second layer of the convolutional neural network to reduce a number of dimensions of the first pool data;
pooling the outcome of performing the second pass as second pool data;
performing a third pass through the a third layer of the convolutional neural network to reduce a number of dimensions of the second pool data;
pooling the outcome of performing the third pass as third pool data; and
performing one or more inner products on the third pool data to create the reduced dimension data.

15. The medium of claim 14, wherein automatically determining anomalies based on classifying the reduced dimension data comprises:
receiving the reduced dimension data at a classifier; and
determining (i) a probability that the reduced dimension data comprises an anomaly and (ii) a probability that the reduced dimension data does not comprise an anomaly.

16. The medium of claim 15, wherein determining (i) the probability that the reduced dimension data comprises an anomaly and (ii) the probability that the reduced dimension data does not comprise an anomaly comprises:
training a system to map the reduced dimension data to a plurality of labels by computation and optimization associated with a loss function.

17. The medium of claim 16, wherein the one or more inner products comprise a first inner product performed on the third pool data and a second inner product performed on an output of the first inner product; and
passing the reduced dimension data to the classifier to determine (i) the probability that the reduced dimension data comprises an anomaly and (ii) the probability that the reduced dimension data does not comprise an anomaly.

18. The medium of claim 15, wherein the reduced dimension data comprises 64 dimensions.
